(19) United States
(12) Patent Application Publication
(10) Pub. No.: US 2026/0170884 A1
(43) Pub. Date: Jun. 18, 2026

(54) METHODS AND APPARATUS TO UPDATE USER INTERFACES

(71) Applicant: Deere & Company, Moline, IL (US)

(72) Inventors: Himanshu Verma, Bettendorf, IA (US); Ajay Singh Kharb, Bettendorf, IA (US); Nicholas M. Cain, Eldridge, IA (US); Vijay S. Taware, Pune (IN); Mandar M. Kale, Pune (IN); Swapnil V. Bhosale, Pune (IN)

(21) Appl. No.: 18/978,994

(22) Filed: Dec. 12, 2024

(51) Int. Cl. G07C 5/02; A01B 76/00; B60R 16/023; G06F 9/451; G07C 5/00

(52) U.S. Cl. CPC G07C 5/02; A01B 76/00; G07C 5/008; B60R 16/0231; G06F 9/451

(57) ABSTRACT

Systems, apparatus, articles of manufacture, and methods are disclosed. An example vehicle comprises a sensor; an actuator; user interface circuitry; machine-readable instructions; and programmable circuitry to at least one of instantiate or execute the machine-readable instructions to: collect vehicle usage data that includes one or more of: a signal produced by the user interface circuitry, a signal produced by the sensor, or a signal produced by the actuator; execute a machine learning model to a) generate a condition and b) identify information that corresponds to the condition, wherein the machine learning model uses a first amount of the vehicle usage data as an input; determine the condition has been satisfied by monitoring a second amount of the vehicle usage data, wherein the second amount of the vehicle usage data is collected after the first amount; and in response to the determination, update the user interface circuitry to present the information.

### FIELD OF THE DISCLOSURE

This disclosure relates generally to user interfaces and, more particularly, to methods and apparatus to update user interfaces.

### BACKGROUND

Agricultural vehicles have become increasingly complex. A given agricultural vehicle may have multiple actuators related to both driving and performing various agricultural operations (plowing, planting, lifting, harvesting, fertilizing, etc.). The agricultural vehicle may also have multiple sensors to measure the agricultural operations, the movement and/or position of the vehicle, etc. Furthermore, many modern agricultural vehicles communicate with external devices to exchange data related to the agricultural operations and/or state of the vehicle. In some examples, the scalability and efficiency of agricultural operations is dependent on an operator's ability to control the various actuators, sensors, and external communications of the agricultural vehicle.

### SUMMARY

Example methods, apparatus, systems, and articles of manufacture to update user interfaces are disclosed herein. Further examples and combinations thereof include the following. Example 1 includes a vehicle comprising a sensor, an actuator, user interface circuitry, machine-readable instructions, and programmable circuitry to at least one of instantiate or execute the machine-readable instructions to collect vehicle usage data that includes one or more of a signal produced by the user interface circuitry, a signal produced by the sensor, or a signal produced by the actuator, execute a machine learning model to a) generate a condition and b) identify information that corresponds to the condition, wherein the machine learning model uses a first amount of the vehicle usage data as an input, determine the condition has been satisfied by monitoring a second amount of the vehicle usage data, wherein the second amount of the vehicle usage data is collected after the first amount, and in response to the determination, update the user interface circuitry to present the information.

Example 2 includes the vehicle of example 1, wherein the user interface circuitry is presenting a first page before the programmable circuitry determines the condition has been satisfied, and to update the user interface circuitry, the programmable circuitry instructs the user interface circuitry to switch from the first page to a second page that contains the information.

Example 3 includes the vehicle of example 1, wherein the user interface circuitry is presenting a page before the programmable circuitry determines the condition has been satisfied, and to update the user interface circuitry, the programmable circuitry instructs the user interface circuitry to present a pop-up window overlaid on the page, the pop-up window to contain the information.

Example 4 includes the vehicle of example 1, wherein the programmable circuitry is to receive one or more of the signals produced by the sensor or the actuator over a controller area network (CAN) bus.

Example 5 includes the vehicle of example 1, wherein the vehicle is an agricultural vehicle, and the sensor is a first sensor in a plurality of sensors that generate part of the vehicle usage data, the plurality of sensors including one or more of a global positioning sensor, an inertial sensor, a camera sensor or a temperature sensor.

Example 6 includes the vehicle of example 1, wherein the vehicle is an agricultural vehicle, and the actuator is a first actuator in a plurality of actuators that generate part of the vehicle usage data, the plurality of actuators including one or more of an engine, a transmission, an axle, a crop header, an auger, or a device connected to the agricultural vehicle on a hitch.

Example 7 includes the vehicle of example 1, wherein the condition and the corresponding information form a first trigger in a plurality of triggers, and the programmable circuitry is to monitor the second amount of vehicle usage data to determine whether one or more of the conditions in the plurality of triggers have been satisfied, and in response to a determination that a condition in the plurality of triggers has been satisfied, update the user interface circuitry to present information from the corresponding trigger.

Example 8 includes the vehicle of example 7, wherein one or more of the plurality of triggers are pre-determined triggers that are stored in a memory of the vehicle before the user interface circuitry, the sensor, or the actuator generate part of the vehicle usage data.

Example 9 includes the vehicle of example 7, wherein the programmable circuitry is to instruct the user interface circuitry to present a page where a user can edit one or more of the plurality of triggers.

Example 10 includes the vehicle of example 7, wherein the programmable circuitry is to instruct the user interface circuitry to present a page where a user can add a trigger to the plurality of triggers.

Example 11 includes the vehicle of example 7, wherein the programmable circuitry is to instruct the user interface circuitry to present a page where a user can remove one or more of the plurality of triggers.

Example 12 includes the vehicle of example 7, wherein the plurality of triggers includes a group of accepted triggers and a group of recommended triggers, the one or more conditions monitored by the programmable circuitry are part of the accepted triggers, and the programmable circuitry is to move a trigger from the group of recommended triggers to the group of accepted triggers in response to a user input that approves of the trigger.

Example 13 includes the vehicle of example 12, wherein the programmable circuitry is to report one or more of the vehicle usage data, the recommended triggers, or the accepted triggers to an external device via a network.

Example 14 includes a method for updating user interface circuitry, the method comprising collecting vehicle usage data that includes one or more of a signal produced by the user interface circuitry, a signal produced by a sensor, or a signal produced by an actuator, executing a machine learning model to a) generate a condition and b) identify information that corresponds to the condition, wherein the machine learning model uses a first amount of the vehicle usage data as an input, determining the condition has been satisfied by monitoring a second amount of the vehicle usage data, wherein the second amount of the vehicle usage data is collected after the first amount, and in response to the determination, updating the user interface circuitry to present the information.

Example 15 includes the method of example 14, further including presenting a first page on the user interface circuitry before the condition has been satisfied, and updating the user interface by switching from the first page to a second page that contains the information.

Example 16 includes the method of example 14, further including presenting a page on the user interface circuitry before the condition has been satisfied, and updating the user interface by presenting a pop-up window overlaid on the page, the pop-up window to contain the information.

Example 17 includes the method of example 14, further including receiving one or more of the signals produced by the sensor or the actuator over a controller area network (CAN) bus.

Example 18 includes the method of example 14, wherein the vehicle usage data corresponds to an agricultural vehicle, and the sensor is a first sensor in a plurality of sensors that generate part of the vehicle usage data, the plurality of sensors including one or more of a global positioning sensor, an inertial sensor, a camera sensor or a temperature sensor.

Example 19 includes the method of example 14, wherein the vehicle usage data corresponds to an agricultural vehicle, and the actuator is a first actuator in a plurality of actuators that generate part of the vehicle usage data, the plurality of actuators including one or more of an engine, a transmission, an axle, a crop header, an auger, or a device connected to the agricultural vehicle on a hitch.

Example 20 includes the method of example 14, wherein the condition and the corresponding information form a first trigger in a plurality of triggers, and the method further includes monitoring the second amount of vehicle usage data to determine whether one or more of the conditions in the plurality of triggers have been satisfied, and in response to a determination that a condition in the plurality of triggers has been satisfied, updating the user interface to present information from the corresponding trigger.

Example 21 includes the method of example 20, wherein the user interface circuitry, the sensor, and the actuator are part of a vehicle, and the method further includes storing one or more of the plurality of triggers as pre-determined triggers in a memory of the vehicle before the user interface circuitry, the sensor, or the actuator generate part of the vehicle usage data.

Example 22 includes the method of example 20, further including presenting a page on the user interface circuitry where a user can edit one or more of the plurality of triggers.

Example 23 includes the method of example 20, further including presenting a page on the user interface circuitry where a user can add a trigger to the plurality of triggers.

Example 24 includes the method of example 20, further including presenting a page on the user interface circuitry where a user can remove one or more of the plurality of triggers.

Example 25 includes the method of example 20, wherein the plurality of triggers includes a group of accepted triggers and a group of recommended triggers, the one or more monitored conditions are part of the accepted triggers, and the method further includes moving a trigger from the group of recommended triggers to the group of accepted triggers in response to a user input that approves of the trigger.

Example 26 includes the method of example 25, further including reporting one or more of the vehicle usage data, the recommended triggers, or the accepted triggers to an external device via a network.

Example 27 includes a non-transitory machine-readable storage medium comprising instructions to cause programmable circuitry to at least collect vehicle usage data that includes one or more of a signal produced by user interface circuitry, a signal produced by a sensor, or a signal produced by an actuator, execute a machine learning model to a) generate a condition and b) identify information that corresponds to the condition, wherein the machine learning model uses a first amount of the vehicle usage data as an input, determine the condition has been satisfied by monitoring a second amount of the vehicle usage data, wherein the second amount of the vehicle usage data is collected after the first amount, and in response to the determination, update the user interface circuitry to present the information.

Example 28 includes the non-transitory machine-readable storage medium of example 27, wherein the user interface circuitry is presenting a first page before the programmable circuitry determines the condition has been satisfied, and to update the user interface circuitry, the programmable circuitry instructs the user interface circuitry to switch from the first page to a second page that contains the information.

Example 29 includes the non-transitory machine-readable storage medium of example 27, wherein the user interface circuitry is presenting a page before the programmable circuitry determines the condition has been satisfied, and to update the user interface circuitry, the programmable circuitry instructs the user interface circuitry to present a pop-up window overlaid on the page, the pop-up window to contain the information.

Example 30 includes the non-transitory machine-readable storage medium of example 27, wherein the programmable circuitry is to receive one or more of the signals produced by the sensor or the actuator over a controller area network (CAN) bus.

Example 31 includes the non-transitory machine-readable storage medium of example 27, wherein the vehicle usage data corresponds to an agricultural vehicle, and the sensor is a first sensor in a plurality of sensors that generate part of the vehicle usage data, the plurality of sensors including one or more of a global positioning sensor, an inertial sensor, a camera sensor or a temperature sensor.

Example 32 includes the non-transitory machine-readable storage medium of example 27, wherein the vehicle usage data corresponds to an agricultural vehicle, and the actuator is a first actuator in a plurality of actuators that generate part of the vehicle usage data, the plurality of actuators including one or more of an engine, a transmission, an axle, a crop header, an auger, or a device connected to the agricultural vehicle on a hitch.

Example 33 includes the non-transitory machine-readable storage medium of example 27, wherein the condition and the corresponding information form a first trigger in a plurality of triggers, and the programmable circuitry is to monitor the second amount of vehicle usage data to determine whether one or more of the conditions in the plurality of triggers have been satisfied, and in response to a determination that a condition in the plurality of triggers has been satisfied, update the user interface circuitry to present information from the corresponding trigger.

Example 34 includes the non-transitory machine-readable storage medium of example 33, wherein the user interface circuitry, the sensor, and the actuator are part of a vehicle, and one or more of the plurality of triggers are pre-determined triggers that are stored in a memory of a vehicle before the user interface circuitry, the sensor, or the actuator generate part of the vehicle usage data.

Example 35 includes the non-transitory machine-readable storage medium of example 33, wherein the programmable circuitry is to instruct the user interface circuitry to present a page where a user can edit one or more of the plurality of triggers.

Example 36 includes the non-transitory machine-readable storage medium of example 33, wherein the programmable circuitry is to instruct the user interface circuitry to present a page where a user can add a trigger to the plurality of triggers.

Example 37 includes the non-transitory machine-readable storage medium of example 33, wherein the programmable circuitry is to instruct the user interface circuitry to present a page where a user can remove one or more of the plurality of triggers.

Example 38 includes the non-transitory machine-readable storage medium of example 33, wherein the plurality of triggers includes a group of accepted triggers and a group of recommended triggers, the one or more conditions monitored by the programmable circuitry are part of the accepted triggers, and the programmable circuitry is to move a trigger from the group of recommended triggers to the group of accepted triggers in response to a user input that approves of the trigger.

Example 39 includes the non-transitory machine-readable storage medium of example 38, wherein the programmable circuitry is to report one or more of the vehicle usage data, the recommended triggers, or the accepted triggers to an external device via a network.

### BRIEF DESCRIPTION OF THE DRAWINGS

FIG. 1 is an illustrative example of an environment that includes a vehicle and server circuitry.

FIG. 2 is a block diagram of an example implementation of the vehicle of FIG. 1.

FIG. 3 is a block diagram of an example implementation of the server circuitry of FIG. 1.

FIG. 4 is an illustrative example of parameters monitored while performing a task with the vehicle of FIG. 1.

FIG. 5 is an illustrative example of a first trigger implemented by the trigger control circuitry of FIG. 2.

FIG. 6 is an illustrative example of a second trigger implemented by the trigger control circuitry of FIG. 2.

FIG. 7 is an illustrative example of a trigger menu presented by the user interface circuitry of FIG. 1.

FIG. 8 is a flowchart representative of example machine-readable instructions and/or example operations that may be executed, instantiated, and/or performed by example programmable circuitry to implement an accepted trigger.

FIG. 9 is a flowchart representative of example machine-readable instructions and/or example operations that may be executed, instantiated, and/or performed by example programmable circuitry to recommend a trigger.

FIG. 10 is a flowchart representative of example machine-readable instructions and/or example operations that may be executed, instantiated, and/or performed by example programmable circuitry to train a trigger recommendation model.

FIG. 11 is a flowchart representative of example machine-readable instructions and/or example operations that may be executed, instantiated, and/or performed by example programmable circuitry to distribute trigger data as described in FIG. 10.

FIG. 12 is a block diagram of an example processing platform including programmable circuitry structured to execute, instantiate, and/or perform the example machine-readable instructions and/or perform the example operations of FIGS. 8, 9, 10, and/or 11 to implement the vehicle 100 and/or server circuitry 118 of FIGS. 2 and 3.

FIG. 13 is a block diagram of an example implementation of the programmable circuitry of FIG. 12.

FIG. 14 is a block diagram of another example implementation of the programmable circuitry of FIG. 12.

FIG. 15 is a block diagram of an example software/firmware/instructions distribution platform (e.g., one or more servers) to distribute software, instructions, and/or firmware (e.g., corresponding to the example machine-readable instructions of FIGS. 8, 9, 10, and/or 11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

In many agricultural vehicles, an operator controls the various actuators, sensors, and external communications through a user interface (UI). The UI may be implemented using, for example, a touch screen display in the cabin of the vehicle that presents information and obtains inputs from the operator.

In recent years, the increasing complexity of agricultural vehicles has presented a need to provide more information through the UI. However, displays in agricultural vehicles generally have small screen sizes as the space within the operator cabin is limited. Additionally, manufacturers and designers of agricultural vehicles may be hesitant to increase the information density of existing pages on a UI because doing so may decrease legibility. Furthermore, increasing information density on a screen may increase the likelihood of the operator becoming distracted by the UI and inadvertently operating the agricultural vehicle in an unsafe manner.

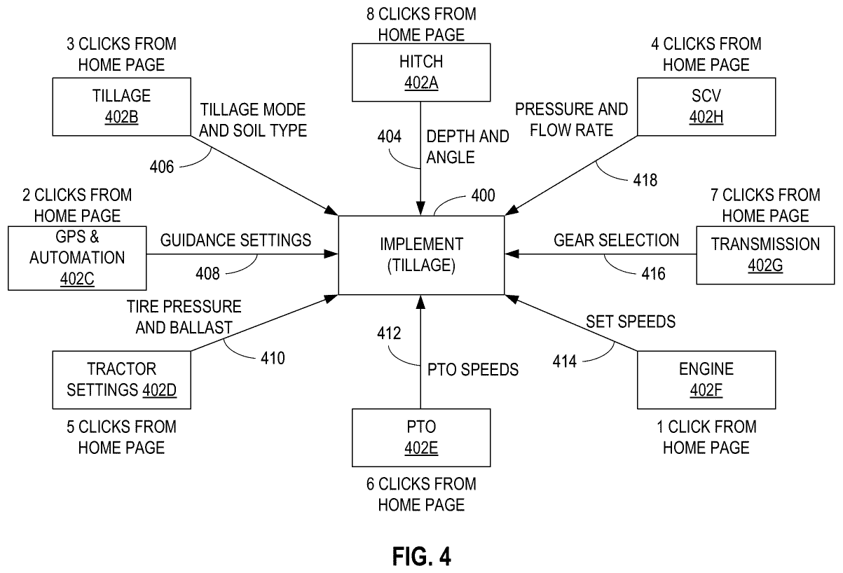

Some manufacturers and designers of agricultural vehicles have added information by increasing the number of pages within the UI. While adding more pages allows for additional information without increasing information density, the new pages introduce additional complexity to the agricultural vehicle. In general, increasing the number of pages in a UI also increases the amount of navigation (e.g., button presses) required for the operator to access the information needed to perform a given task. The additional navigation slows down the operator's efforts to perform the agricultural task, thereby decreasing the efficiency of the task and the user experience associated with the agricultural vehicle. The additional navigation also increases the likelihood that the operator becomes distracted by the UI, thereby causing additional safety concerns. An example of UI navigation is described further in connection with FIG. 4.

Example methods, apparatus, and systems described herein implement a system that reduces the complexity of navigating a UI that has large amounts of information. An example control system includes trigger control circuitry that implements one or more triggers. A trigger includes a condition and instructions to update the UI. The trigger control circuitry monitors the state of the vehicle and, in response to a change that satisfies the condition of a trigger, updates the UI using the corresponding instructions. The control system also includes model executor circuitry that generates recommendations for new triggers by executing a machine learning model. The machine learning model is trained remotely based on a global network of vehicles but recommends new triggers based on the vehicle usage data associated with a particular operator. The control system also instructs the UI to present a page where an operator can add, edit, or remove both accepted triggers (e.g., triggers that are actively being implemented by the control system) and recommended triggers (e.g., triggers that are not currently implemented by the control system). Accordingly, a UI implemented using the examples described herein is less complex, supports more efficient operations, reduces distractedness, and generally provides improves user experience compared to a different UI that has the same amount of information.

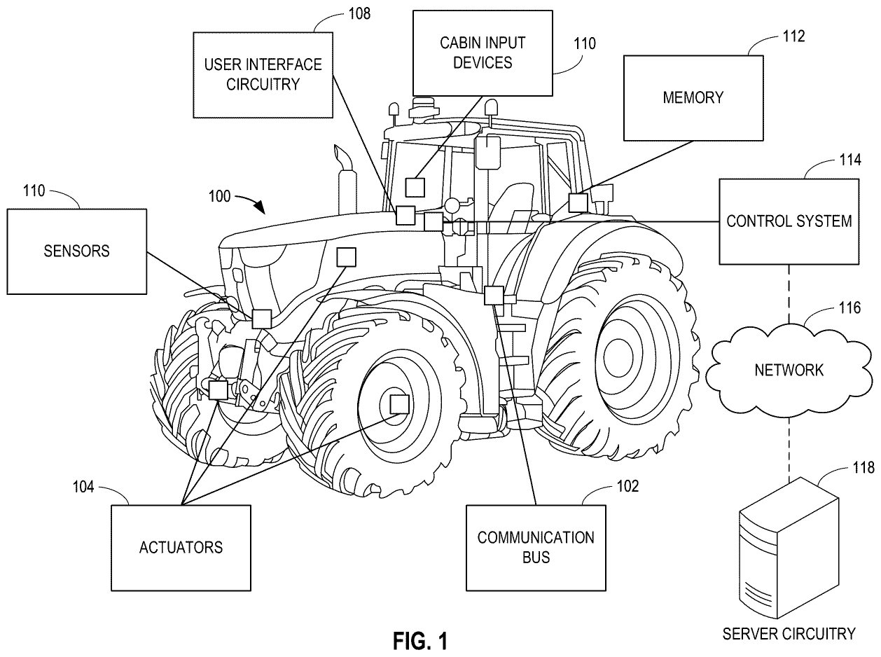

FIG. 1 is an illustrative example of a vehicle 100. The example of FIG. 1 shows that the vehicle 100 includes a communication bus 102, actuators 104, sensors 106, user interface circuitry 108, cabin input devices 110, memory 112, and a control system 114. While the example of FIG. 1 points to various locations of the vehicle 100 for illustrative purposes, the communication bus 102, the actuators 104, the sensors 106, the memory 112, and the control system 114 may be implemented at any location(s) within and/or throughout the vehicle 100. The example of FIG. 1 also includes a network 116 and server circuitry 118.

The vehicle 100 refers to any type of vehicle that has a UI. In the example of FIG. 1, the vehicle 100 is a tractor. In other examples, the vehicle 100 is a different type of vehicle including but not limited to a combine, a mower, a fertilizer, a sprayer, a truck, etc. While the examples below refer to the vehicle 100, the teachings described herein are applicable to any type of UI, including UIs that are not implemented on a vehicle and UIs that are not implemented in an agricultural context.

The communication bus 102 refers to one or more physical connections that enable communication between the other components of the vehicle 100. The communication bus 102 may be implemented using one or more protocols that meet pre-determined threshold power and latency requirements. Such communication protocols include but are not limited to: Controller Area Network (CAN), Ethernet, etc.

The actuators 104 refer to one or more components of vehicle 100 that convert a first type of energy into mechanical energy. The first type of energy may be implemented by any suitable input to a given actuator, including but not limited to electrical energy, pneumatic energy, hydraulic energy, etc. The actuators 104 may use the mechanical energy in a variety of forms, including but not limited to the application of a force or a torque, a movement or displacement of a component, etc. In the example of FIG. 1, one or more of the actuators 104 are implemented within, and are not detachable from, the vehicle 100. Such actuators include but are not limited to an engine, a transmission, an axle, a crop header, an auger, a front-end loader, a backhoe, etc. In some examples, one or more of the actuators 104 are external devices that can attach and detach to the vehicle 100 depending on the use case. Such actuators include but are not limited to balers, sprayers, tillers, cultivators, threshers, etc. The vehicle 100 may implement and/or attach to any number of actuators 104.

The sensors 106 refer to one or more devices that measure and/or obtain vehicle data corresponding to the vehicle 100. In the example of FIG. 1, the sensors 106 include a position sensor (e.g., a global positioning sensor (GPS)) to detect a geographic position of the vehicle 100. Additionally or alternatively, the sensors 106 can include an inertial sensor (e.g., an accelerometer, a gyroscope, etc.) to measure acceleration, velocity, and/or orientation (e.g., yaw, pitch, and/or roll) of the vehicle 100. In some examples, the vehicle 100 includes other sensors including but not limited to a temperature sensor, Global Navigation Satellite Systems (GNSS) sensors, Light Detection and Ranging (LIDAR) sensors, Radio Detection and Ranging (RADAR) sensors, sound Navigation Ranging (SONAR) sensors, telematics sensors, etc.

The user interface circuitry 108 presents a UI on a display. The UI generally contains information regarding the actuators 104, the sensors 106, and/or communication between the vehicle 100 and an external device. The information presented on the user interface circuitry 108 at any given time changes responsive to instructions from the control system 114. The user interface circuitry 108 also obtains inputs from an operator. The inputs obtained by the user interface circuitry 108 represent instructions related to the information being presented. For example, the inputs may cause the user interface circuitry 108 to open a page within the UI, move to a different page of the UI, enter a value, etc. In the example of FIG. 1, the user interface circuitry 108 includes a touch screen that is used to both present information and obtain inputs.

The cabin input devices 110 refer to one or more components that the operator uses to control the actuators 104 and/or the sensors 106. Such cabin input devices 110 include but are not limited to a steering wheel, pedals, control stalks, dials, buttons, shifters, joysticks, etc. In some examples, a signal generated by one of the cabin input devices 110 also causes an update to the information presented on the user interface circuitry 108.

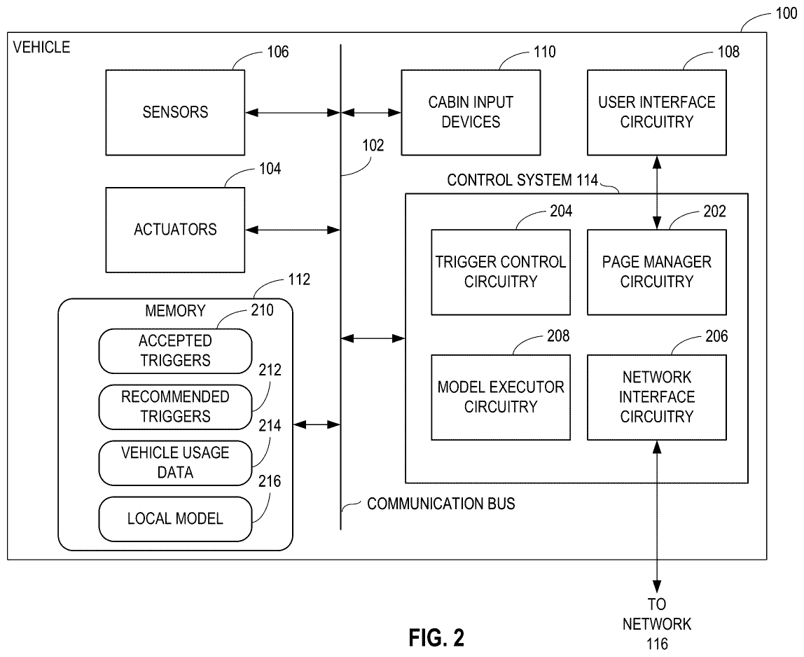

The memory 112 stores data used by one or more components of the vehicle 100 to perform operations. For example, the memory 112 may store sensor measurements, actuator configuration data, data that relates to the presentation of information on the user interface circuitry 108, etc. The memory 112 may be implemented as any type of memory. For example, the memory 112 may be a volatile memory or a non-volatile memory. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device. The memory 112 is described further in connection with FIG. 2.

The control system 114 manages the operations of the other components within the vehicle 100. In the example of FIG. 1, the control system 114 transmits signals via the communication bus 102 that cause one or more of the actuators 104 to move, cause one or more of the sensors 106 to perform a measurement, present information on the user interface circuitry 108, and/or provide data to an external device such as the server circuitry 118. The control system 114 may also receive signals via the communication bus 102 that contain operator inputs from the cabin input devices 110 or the user interface circuitry 108, measurement data from the sensors 106, status data from the actuators 104, etc. In some examples, data that the control system 114 receives from one or more of the actuators 104, the sensors 106, the user interface circuitry 108, and/or the cabin input devices 110 is referred to as vehicle usage data.

The control system 114 may be implemented by any type of programmable circuitry. Examples of programmable circuitry include but are not limited to programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). The control system 114 is described further in connection with FIG. 2.

The network 116 connects and facilitates communication between the control system 114 and devices external to the vehicle 100. Such devices include but are not limited to the server circuitry 118. In this example, the network 116 is the Internet. However, the example network 116 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

The server circuitry 118 trains machine learning models that generate triggers. As used above and herein, a trigger refers to: a) a condition that may be satisfied based on vehicle usage data, and b) instructions that describe how to change the information presented on the user interface circuitry 108. The server circuitry 118 trains the machine leaning model based on vehicle usage data from both the vehicle 100 and vehicle usage data from other vehicles (e.g., other tractors, combines, etc.). The server circuitry 118 then transmits a copy of the trained model to the control system 114 via the network 116.

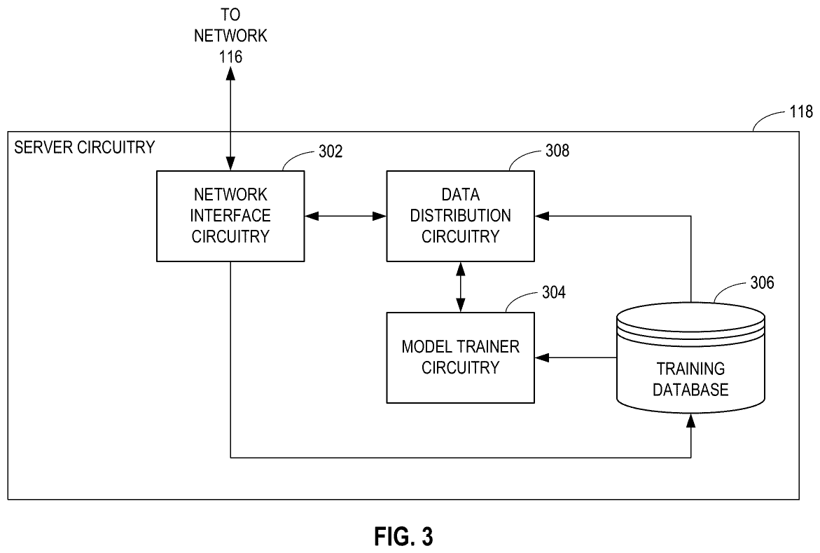

The server circuitry 118 may be implemented with any type of programmable circuitry. More generally, the server circuitry 118 may be implemented with any hardware components (programmable circuitry, power supplies, cooling systems, etc.) suitable to train and update machine learning models. The server circuitry 118 is described further in connection with FIG. 3.

The control system 114 determines what information to present on the user interface circuitry 108 in part by locally executing the copy of the machine learning model. In general, the triggers implemented by the control system improve user experience and efficiency by automatically presenting relevant information to an operator when a certain condition is met, thereby removing the complexity of manually finding said information amongst the multitude of pages in the UI. Additionally, the local execution of the machine learning model enables the control system 114 to recommend triggers that are specific to the preferences and workflow of a particular operator, thereby providing greater customizability and improved user experience than UIs without triggers.

FIG. 2 is a block diagram of an example implementation of the vehicle 100 of FIG. 1. The example of FIG. 2 includes the communication bus 102, the actuators 104, the sensors 106, the user interface circuitry 108, the cabin input devices 110, the memory 112, and the control system 114 of FIG. 1. In the example of FIG. 2, the control system 114 includes page manager circuitry 202, trigger control circuitry 204, network interface circuitry 206, and model executor circuitry 208. The memory 112 includes accepted trigger 210A, 210B, . . . (collectively referred to as accepted triggers 210) recommended trigger 212A, 212B, . . . (collectively referred to as recommended triggers 212), vehicle usage data 214, and a local model 216.

The control system 114 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the control system 114 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

Within the control system 114, the page manager circuitry 202 determines what visuals to present on the screen of the user interface circuitry 108. To do so, the page manager circuitry 202 maintains a UI that organizes the information available for presentation into multiple pages. As used herein, a page refers to any information that may be presented on the screen of the user interface circuitry 108 at a given time. Accordingly, a page may include graphics, color schemes, icons, one or more pieces of information from the vehicle usage data, etc. In some examples, the pages are referred to as menus.

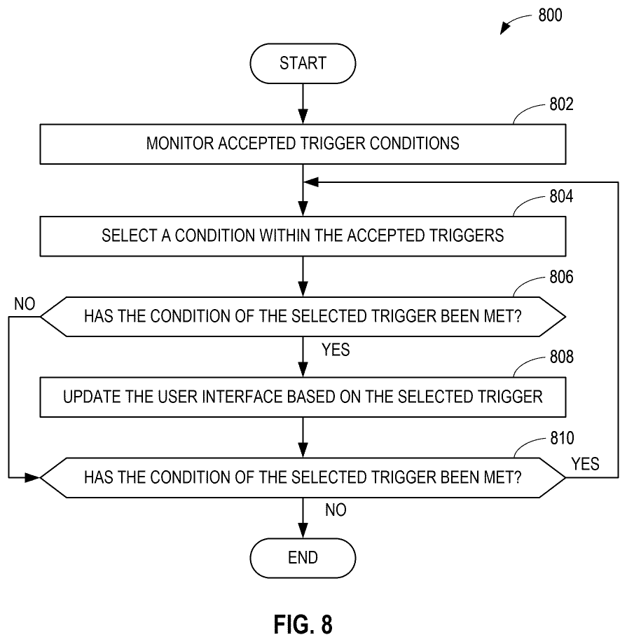

The page manager circuitry 202 updates the UI (e.g., changes the screen to a different page, adjusts content within an existing page, etc.) based on operator inputs received via the touch screen of the user interface circuitry 108. For example, the operator may select a digital button on a first page that causes the page manager circuitry 202 to change the screen to a second page. The page manager circuitry 202 can also update the UI based on a change in vehicle usage data caused by one or more of the actuators 104, sensors, or cabin input devices 110. For example, a change in coordinates produced by a GPS sensor may cause the page manager circuitry 202 to update the position of the vehicle on a digital map that is displayed on a page. The page manager circuitry 202 can also update the UI to present data received in communication with an external device. In some examples, the page manager circuitry 202 is instantiated by programmable circuitry executing page manager instructions and/or configured to perform operations such as those represented by the flowchart(s) of FIGS. 8, 9, 10, and/or 11.

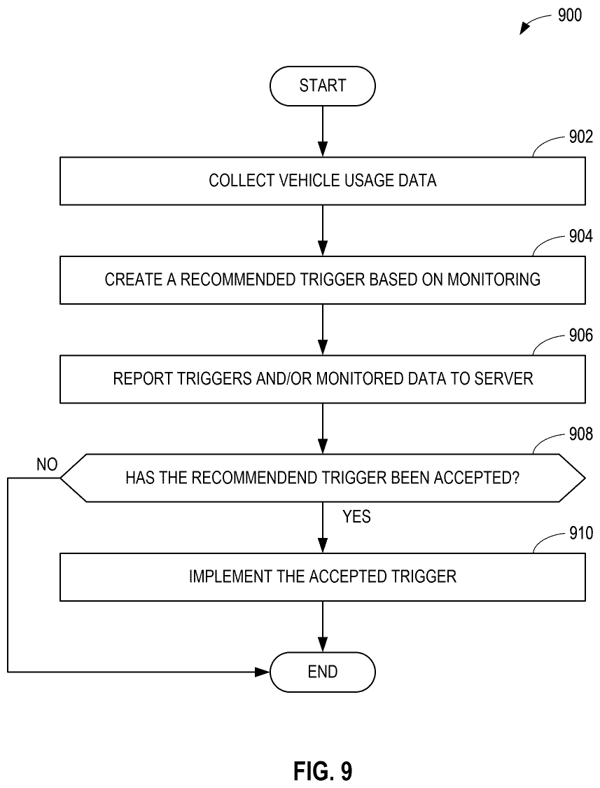

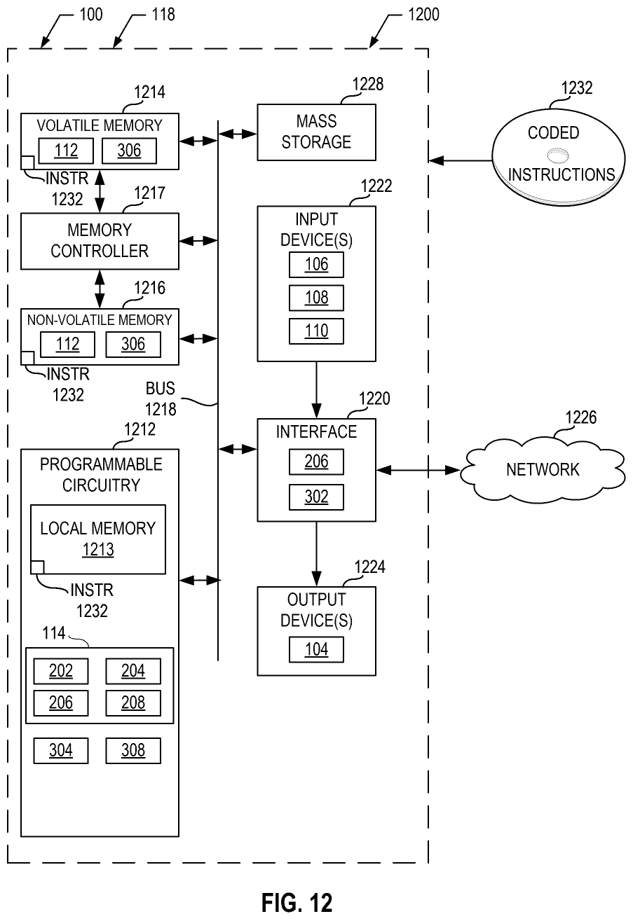

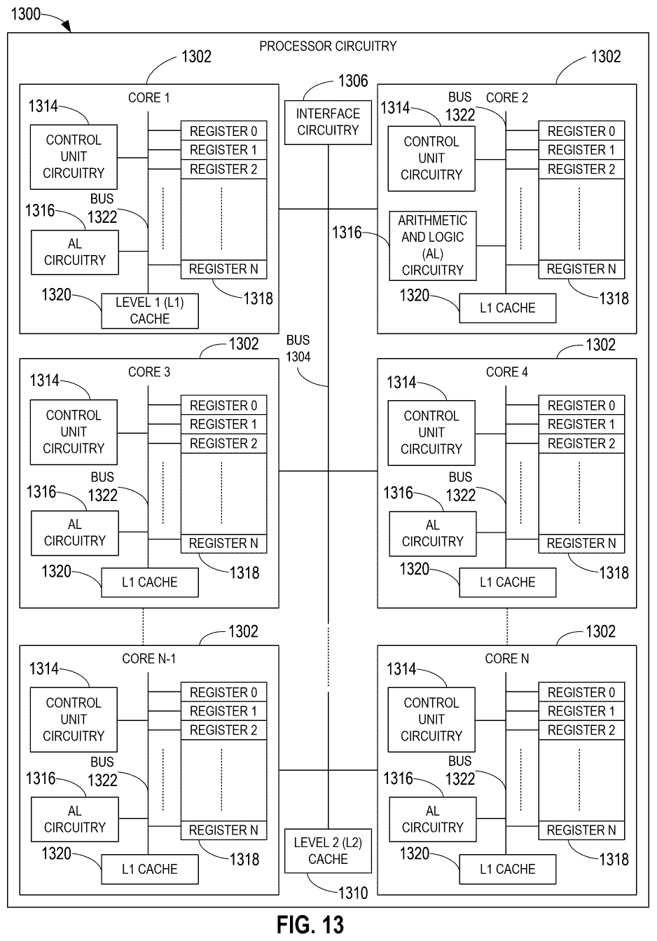

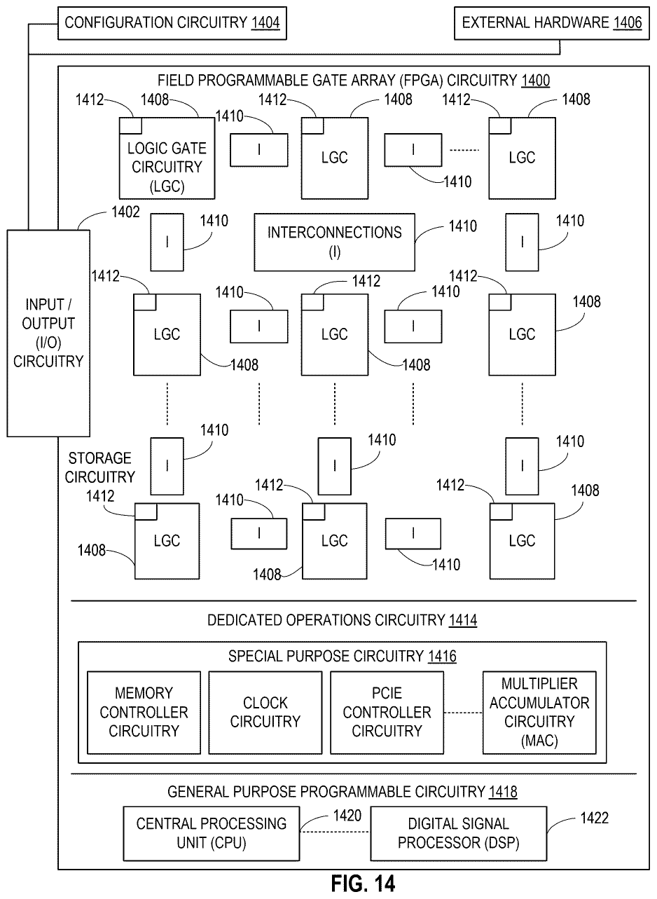

In some examples, the control system 114 includes means for determining a condition of a device. For example, the means for determining may be implemented by page manager circuitry 202. In some examples, the page manager circuitry 202 may be instantiated by programmable circuitry such as the example programmable circuitry 1212 of FIG. 12. For instance, the page manager circuitry 202 may be instantiated by the example microprocessor 1300 of FIG. 13 executing machine executable instructions such as those implemented by at least blocks 808, 910 of FIGS. 8 and 9. In some examples, the page manager circuitry 202 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the page manager circuitry 202 may be instantiated by any other combination of hardware, software, and/or firmware. For example, the page manager circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The trigger control circuitry 204 implements the accepted triggers 210 by determining whether any of the conditions in the accepted triggers 210 to become satisfied. As used above and herein, a condition refers to a logical condition that: a) uses one or more parameters within the vehicle usage data 214 as inputs and b) resolves to a binary state (e.g., true or false, satisfied or not satisfied, etc.) when evaluated. Different parameters within the vehicle usage data 214 may change values at different times depending on how the components within the vehicle 100 are used in operation. Accordingly, the trigger control circuitry 204 repeatedly checks the vehicle usage data 214 to determine whether a change in one or more parameters has caused a condition to change states (e.g., from false to true or vice versa). In some examples, the trigger control circuitry 204 continuously or periodically checks the vehicle usage data 214 based on a clock signal.

When the condition for an accepted trigger 210A has been satisfied, the trigger control circuitry 204 provides the corresponding the instructions contained within said trigger 210A to the page manager circuitry 202. The instructions cause the page manager circuitry 202 to update the user interface circuitry 108, thereby presenting new information to the operator. In some examples, the trigger control circuitry 204 is instantiated by programmable circuitry executing trigger control instructions and/or configured to perform operations such as those represented by the flowchart(s) of FIGS. 8, 9, 10, and/or 11.

In some examples, the control system 114 includes means for determining a condition of a device. For example, the means for determining may be implemented by trigger control circuitry 204. In some examples, the trigger control circuitry 204 may be instantiated by programmable circuitry such as the example programmable circuitry 1212 of FIG. 12. For instance, the trigger control circuitry 204 may be instantiated by the example microprocessor 1300 of FIG. 13 executing machine executable instructions such as those implemented by at least blocks 802-810, 910 of FIGS. 8 and 9. In some examples, the trigger control circuitry 204 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the trigger control circuitry 204 may be instantiated by any other combination of hardware, software, and/or firmware. For example, the trigger control circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The network interface circuitry 206 enables other components within the control system 114 to send or receive data over the network 116. For example, the network interface circuitry 206 uses the network 116 to transmit one or more parameters from the vehicle usage data 214 to the server circuitry 118 for use in training the machine learning model. The network interface circuitry 206 also receives one or more versions of the local model 216 via the network 116. The network interface circuitry 206 may include transceivers, antennas, and/or other hardware components required to send and receive data over the network 116. In some examples, the network interface circuitry 206 is instantiated by programmable circuitry executing network interface instructions and/or configured to perform operations such as those represented by the flowchart(s) of FIGS. 8, 9, 10, and/or 11.

In some examples, the control system 114 includes means for determining a condition of a device. For example, the means for determining may be implemented by network interface circuitry 206. In some examples, the network interface circuitry 206 may be instantiated by programmable circuitry such as the example programmable circuitry 1212 of FIG. 12. For instance, the network interface circuitry 206 may be instantiated by the example microprocessor 1300 of FIG. 13 executing machine executable instructions such as those implemented by at least blocks 906 of FIG. 9. In some examples, the network interface circuitry 206 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the network interface circuitry 206 may be instantiated by any other combination of hardware, software, and/or firmware. For example, the network interface circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The model executor circuitry 208 generates one or more of the recommended triggers 212. Like the accepted triggers 210, a recommended trigger consists of both a) a condition that resolves to a binary state based on the vehicle usage data 214 and b) instructions that, when executed, cause the page manager circuitry 202 to update the UI and present new information. The trigger control circuitry 204 monitors vehicle usage data 214 to determine whether the conditions in the accepted triggers 210 have been satisfied but does not check the conditions in the recommended triggers 212. Thus, a trigger that begins as a recommendation is not implemented (e.g., the instructions to update the UI are not provided to the page manager circuitry 202) unless and until the operator accepts the trigger.

The model executor circuitry 208 generates a recommended trigger performing operations based on the instructions in the local model 216 (e.g., executing the local model 216). The instructions cause the model executor circuitry 208 to generate conditions and corresponding updates to the UI based on how the vehicle usage data 214 changes over time. Accordingly, the model executor circuitry 208 learns the preferences and workflow of a particular operator based on how the vehicle usage data 214 changes when the operator is using the 100. The model executor circuitry 208 then populates the recommended triggers 212 with custom triggers that are designed to improve the user experience of the particular operator. The machine learning model used by the model executor circuitry 208 is described further in connection with FIG. 3. In some examples, the model executor circuitry 208 is instantiated by programmable circuitry executing model executor instructions and/or configured to perform operations such as those represented by the flowchart(s) of FIGS. 8, 9, 10, and/or 11.

In some examples, the control system 114 includes means for determining a condition of a device. For example, the means for determining may be implemented by model executor circuitry 208. In some examples, the model executor circuitry 208 may be instantiated by programmable circuitry such as the example programmable circuitry 1212 of FIG. 12. For instance, the model executor circuitry 208 may be instantiated by the example microprocessor 1300 of FIG. 13 executing machine executable instructions such as those implemented by at least blocks 902, 904 of FIG. 9. In some examples, the model executor circuitry 208 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the model executor circuitry 208 may be instantiated by any other combination of hardware, software, and/or firmware. For example, the model executor circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

FIG. 3 is a block diagram of an example implementation of the server circuitry 118 of FIG. 1. The example of FIG. 3 shows the server circuitry 118 includes network interface circuitry 302, model trainer circuitry 304, a training database 306, and data distribution circuitry 308.

The network interface circuitry 302 enables other components within the server circuitry 118 to send or receive data over the network 116. The network interface circuitry 206 may include transceivers, antennas, and/or other hardware components required to send and receive data over the network 116. In some examples, the network interface circuitry 302 is instantiated by programmable circuitry executing network interface instructions and/or configured to perform operations such as those represented by the flowchart(s) of FIGS. 8, 9, 10, and/or 11.

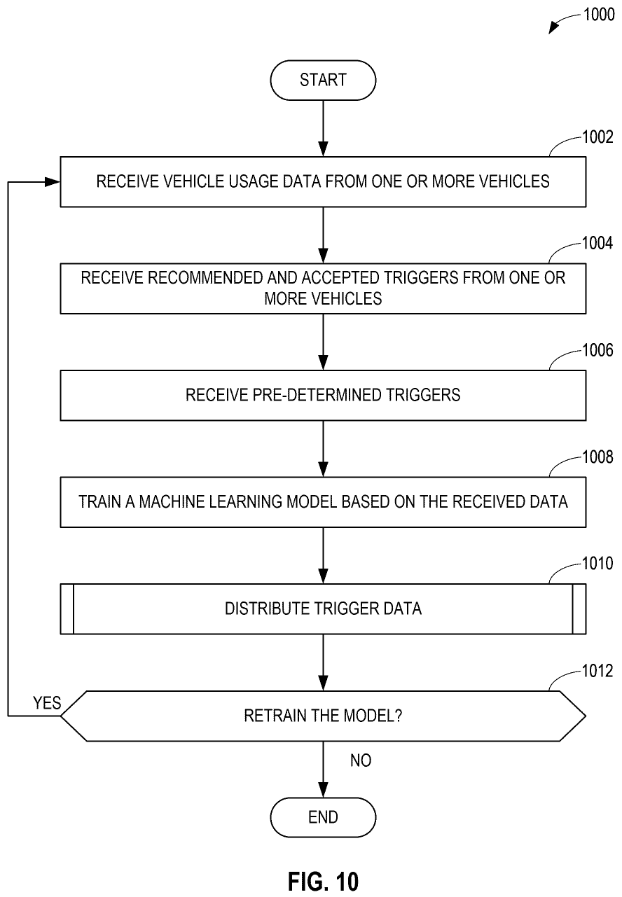

In some examples, the server circuitry 118 includes means for determining a condition of a device. For example, the means for determining may be implemented by network interface circuitry 302. In some examples, the network interface circuitry 302 may be instantiated by programmable circuitry such as the example programmable circuitry 1212 of FIG. 12. For instance, the network interface circuitry 302 may be instantiated by the example microprocessor 1300 of FIG. 13 executing machine executable instructions such as those implemented by at least blocks 1002-1008 of FIG. 10. In some examples, the network interface circuitry 302 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the network interface circuitry 302 may be instantiated by any other combination of hardware, software, and/or firmware. For example, the network interface circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, the model trainer circuitry 304 trains a regression-based model. Using a regression model enables the model trainer circuitry 304 to estimate the relationship between a dependent variable (e.g., a first parameter in the vehicle usage data) and one or more independent variables (e.g., other parameters in the vehicle usage data). In general, machine learning models/architectures that are suitable to use in the example approaches disclosed herein will generate predictions based on user behavior. Other machine learning models that may be used to predict user behavior include decision trees and neural networks. However, in some examples, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. In the example of FIG. 3, the model trainer circuitry 304 uses supervised training. In general, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) In other examples, the model trainer circuitry 304 uses unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, the model trainer circuitry 304 trains machine learning models to generate triggers as described above. In examples disclosed herein, training is performed until a confidence level associated with the generated triggers exceeds a threshold. A confidence level may be a parameter that quantifies how likely an operator is to accept and implement the trigger. In some examples, the confidence level is a function of how related the condition within a trigger and the corresponding update to the UI are to one another.

In some examples, the model trainer circuitry 304 performs retraining. The retraining may be performed in response to feedback from the vehicle 100 that indicates a threshold portion of the recommended triggers 212 are being deleted or edited instead of accepted. Such feedback generally indicates the model executor circuitry 208 is not generating recommendations that are useful to the operator, which may indicate that a new version of the local model 216 is needed. In some examples, model retraining is referred to as model tuning.

In some examples, the server circuitry 118 includes means for determining a condition of a device. For example, the means for determining may be implemented by model trainer circuitry 304. In some examples, the model trainer circuitry 304 may be instantiated by programmable circuitry such as the example programmable circuitry 1212 of FIG. 12. For instance, the model trainer circuitry 304 may be instantiated by the example microprocessor 1300 of FIG. 13 executing machine executable instructions such as those implemented by at least blocks 1008, 1012 of FIGS. 10 and 12. In some examples, the model trainer circuitry 304 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the model trainer circuitry 304 may be instantiated by any other combination of hardware, software, and/or firmware. For example, the model trainer circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

The model trainer circuitry 304 performs training using data from the training database 306. In examples disclosed herein, the training database 306 stores accepted triggers 210, recommended triggers 212, and vehicle usage data 214 from multiple vehicles that include but are not limited to the vehicle 100. Because supervised training is used, the training data is labeled. In this example, the labels may include which vehicle a given piece of data comes from, when the data was generated, which component (a sensor, an actuator, etc.) generated a given parameter in the vehicle usage data, whether the trigger was accepted or recommended, whether a trigger was edited before acceptance, etc. In some examples, a developer of the machine learning model manually populates the training database 306 with labelled data. Such manual entry may be performed to provide the model trainer circuitry 304 with exemplary triggers that are widely accepted and implemented across a fleet of vehicles. In other examples, data is manually entered into the training database 306 for different reasons.

Once training is complete, the data distribution circuitry 308 deploys a copy of the model via the network 116 for use as an executable construct that processes an input and provides an output based on the network of nodes and connections defined in the model. The copy of the model is referred to in FIG. 2 as the local model 216 and is executed by the model executor circuitry 208 to generate custom trigger recommendations as described above.

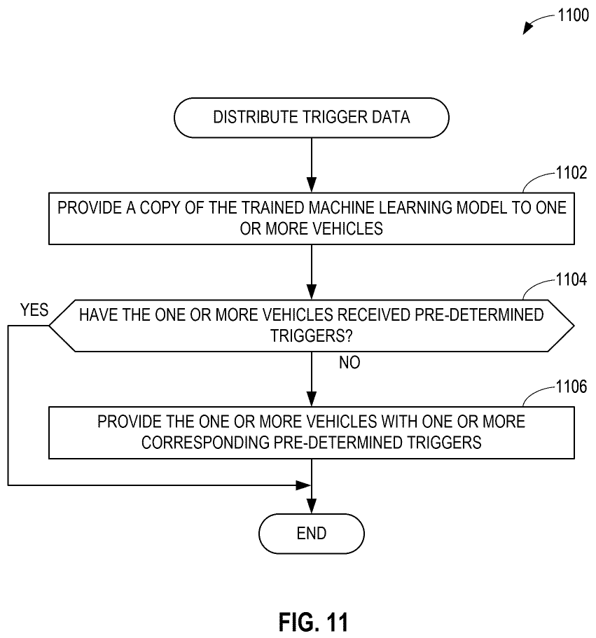

In some examples, the server circuitry 118 includes means for determining a condition of a device. For example, the means for determining may be implemented by data distribution circuitry 308. In some examples, the data distribution circuitry 308 may be instantiated by programmable circuitry such as the example programmable circuitry 1212 of FIG. 12. For instance, the data distribution circuitry 308 may be instantiated by the example microprocessor 1300 of FIG. 13 executing machine executable instructions such as those implemented by at least blocks 1010, 1102-1106 of FIGS. 10 and 11. In some examples, the data distribution circuitry 308 may be instantiated by hardware logic circuitry, which may be implemented by an ASIC, XPU, or the FPGA circuitry 1400 of FIG. 14 configured and/or structured to perform operations corresponding to the machine-readable instructions. Additionally or alternatively, the data distribution circuitry 308 may be instantiated by any other combination of hardware, software, and/or firmware. For example, the data distribution circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the vehicle 100 transmits the output of the deployed model (e.g., the custom trigger recommendations) to the server circuitry 118 as feedback. The vehicle 100 may additionally provide additional metadata as feedback including but not limited to whether a trigger recommendation was accepted, edited, or deleted by an operator. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

FIG. 4 is an illustrative example of parameters monitored while performing a task with the vehicle 100 of FIG. 1. The example of FIG. 4 includes a task 400, user interface pages 402A, 402B, 402C, 402D, 402E, 402F, 402G, 402H (collectively referred to as UI pages 402), and parameters 404, 406, 408, 410, 412, 414, 416, and 418.

The task 400 refers to any task that an operator may use the vehicle 100 to perform. In the example of FIG. 4, the task 400 is tillage, which refers generally to the preparation of land for growing crops. In some examples, tillage includes driving the vehicle 100 over a field with one or more attachable actuators to mechanically agitate soil through digging, stirring, overturning, etc.

In general, performance of a task requires the operator to monitor and/or edit one or more parameters within the vehicle usage data 214. In the example of FIG. 4, performance of the task 400 includes the monitoring and/or editing of the depth and angle of a disc plow (parameter 404), the tillage mode and soil type (parameters 406), location guidance settings (parameter 408), tire pressure and ballast (parameters 410), Power Take Off (PTO) speeds (parameter 412), engine speeds (parameter 414), transmission gears (parameter 416), pressure and flow rate (parameters 418). In other examples, the operator monitors and/or edits different parameters within the vehicle usage data 214 to perform a task.

The operator uses the user interface circuitry 108 to monitor and/or edit the one or more vehicle usage data parameters before or during the performance of a task. The desired vehicle usage data parameters may be separated across multiple different pages of the UI. For example, suppose the page manager circuitry 202 implements a home page that is presented on the user interface circuitry 108 whenever the vehicle first turns on. In the example of FIG. 4, the parameters 404 are part of the UI page 402A which is labeled “hitch” and is located eight clicks (e.g., button presses) away from the home page. Similarly, parameters 406 are on the UI page 402B which is located three clicks away from the home page, parameters 408 are on the UI page which is located two clicks away from the home page, etc. Thus, in the example of FIG. 4, an operator that accessed the parameters 404-418 by visiting all of the UI pages 402 and returning to the home page between each one would have made at least 36 different clicks (as 8+3+2+5+6+1+7+4 =36).

In some examples, the number of clicks made by an operator during a task may be reduced due to the presence of links on some UI pages (e.g., 402A) that, when clicked, causes the display to update directly to different UI pages (e.g., 402B) without showing the home page as an intermediate destination. However, the number of clicks made by an operator during a task may be additionally or alternatively increased due to an operator's need or desire to access some of the parameters 404-418 more than once. More generally, FIG. 4 shows that the need or desire to monitor and/or edit a large amount of vehicle usage data can cause operators to spend a large amount of time interacting with UIs that do not implement triggers. Such excessive interaction time decreases the efficiency of the task 400 and decreases the user experience of the vehicle.

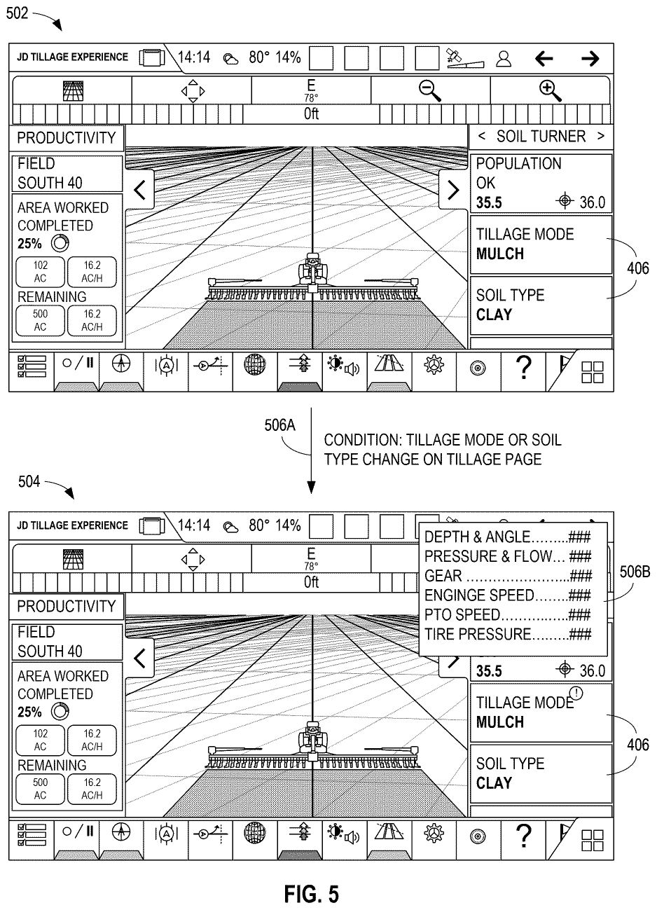

FIG. 5 is an illustrative example of a first trigger implemented by the trigger control circuitry 204 of FIG. 2. The example of FIG. 5 includes views 502 and 504, the condition 506A, and an update 506B. The condition and update are collectively referred to as a trigger 506.

FIG. 5 provides an example for how a UI that implements triggers as described herein can be used to implement the task 400 of FIG. 4. The view 502 is an example illustration of the tillage UI page 402B before the trigger 506 is implemented. The tillage UI page 402B includes space to view and/or edit the tillage mode and soil type (the parameters 406 of FIG. 4) on the right side of the screen. The tillage UI page 402B also includes additional buttons, graphics, and various pieces of vehicle usage data related to tillage. However, the tillage UI page 402B does not include all of the parameters 404-418 that the operator monitors and/or edits in the example of FIG. 4.

In general, the condition of a trigger is used to identify when an operator is beginning/performing a particular task. In the example of FIG. 5, the trigger control circuitry 204 determines the condition 506A has been satisfied (and therefore identifies the beginning of the task 400) by checking whether the tillage mode parameter or the soil type parameter has been changed.

In general, an update in a trigger presents the relevant vehicle usage data on the user interface circuitry 108 that helps the operator perform/complete the task. For example, in response to determining the condition 506A is satisfied, the page manager circuitry 202 implements the update 506B to change the visuals on the screen from the view 502 to the view 504. The view 504 includes a pop-up window overlaid on the same the tillage UI page 402B as the view 502. The pop-up window includes the remaining parameters 404, 408-418 from FIG. 4.

Notably, the control system 114 automatically presents the pop-up window in response to the operator changing the tillage mode or the soil type. Thus, compared to a UI that does not implement triggers, the control system 114 reduces the number of button presses that the operator needs to make to the user interface circuitry 108 to complete the task 400. The reduced number of clicks improves the efficiency of the task 400 and improves user experience.

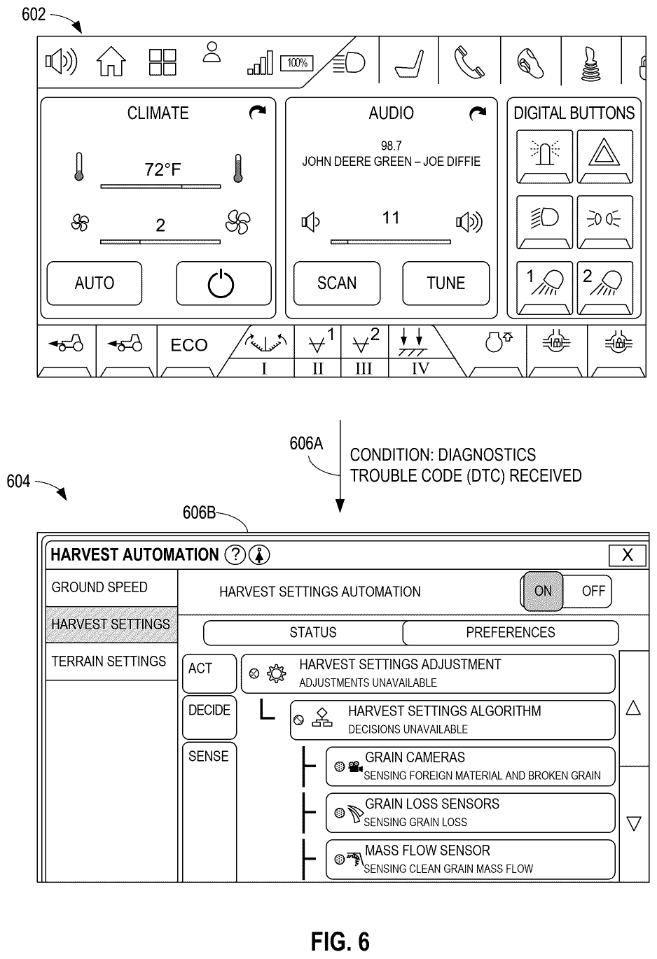

FIG. 6 is an illustrative example of a second trigger implemented by the trigger control circuitry 204 of FIG. 2. The example of FIG. 5 includes views 602 and 604, the condition 606A, and an update 606B. The condition and update are collectively referred to as a trigger 606.

The view 602 represents the visuals on the user interface circuitry 108 before the trigger 606 is implemented. In the example of FIG. 6, the view 602 is a UI page used for climate, audio, and other cabin controls. In other examples, the view 602 may be a different UI page.

Some triggers cause the control system 114 to present vehicle usage data that is unrelated to the current task performed by the operator. For example, the trigger control circuitry 204 determines the condition 606A is satisfied when one or more of the sensors 106 used for harvesting transmit a diagnostics trouble code (DTC) to the control system 114. A DTC refers to a message within a vehicle's onboard diagnostics (OBD) system that indicates a problem with a particular component. In the example of FIG. 6, the presence of DTC represents a significant error that requires further investigation and correction from the operator. Thus, in response to the condition 606A, the update 606B causes the page manager circuitry 202 to present a new UI page on the view 604 that allows for diagnosing harvest settings algorithms, grain cameras, grain loss sensors, and a mass flow sensor. More generally, updates to the user interface circuitry 108 caused by a trigger include but are not limited to pop-up window over an existing page or a transition to a new page. Additionally, the vehicle usage data presented by a trigger may be related or unrelated to the current task being performed by the operator.

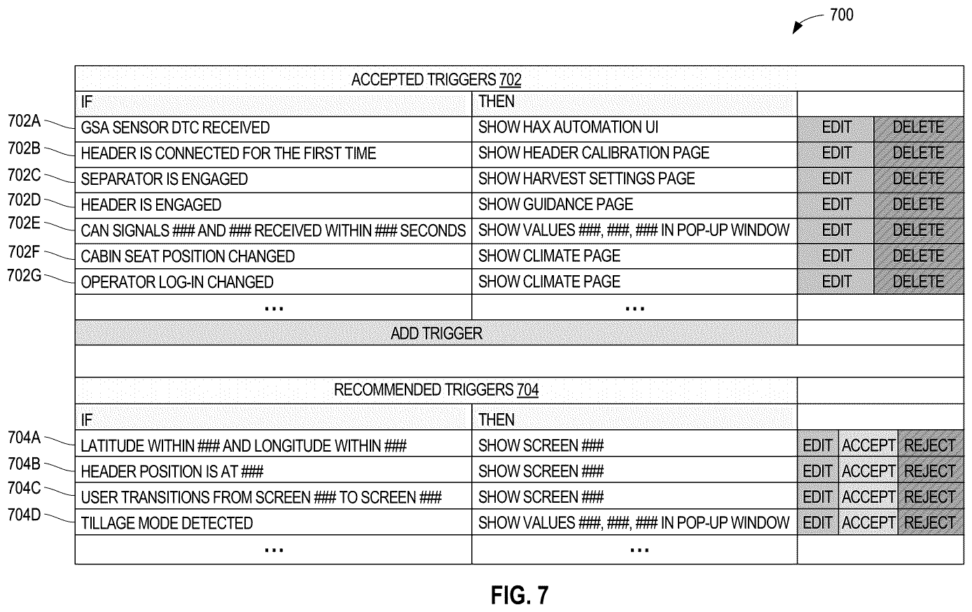

FIG. 7 is an illustrative example of a trigger page 700 presented by the user interface circuitry 108 of FIG. 1. In the example of FIG. 7, the trigger page 700 includes accepted triggers 702A, 702B, . . . , (collectively referred to as accepted triggers 702) and recommended triggers 704A, 704B, . . . , (collectively referred to as recommended triggers 704). The accepted triggers 702 and the recommended triggers 704 are example implementations of the accepted triggers 210 and the recommended triggers 212 of FIG. 2, respectively.

In the example of FIG. 7, triggers are represented as “if-then” statements where “if” represents the condition of the trigger and “then” represents the update to the user interface circuitry 108 that occurs if the condition is satisfied. Both the accepted triggers 702 and the recommended triggers 704 may relate to any type of task that can be performed with the vehicle. In this example, the trigger control circuitry 204 monitors portions of the vehicle usage data 214 including but not limited to: whether a DTC code has been received, whether a separator or header actuators are engaged, whether various CAN signals are received within a threshold amount of time from one another, whether a cabin seat position has changed, whether a different operator has logged in to use the vehicle 100, etc. to determine whether any of the conditions in the accepted triggers 702 have been satisfied. Similarly, the “then” column shows the updates to the UI include but are not limited to switching to various pages, overlaying an existing page with a pop-up window, displaying various parameters on the new UI page or pop-up window, etc.

In some examples, the trigger control circuitry 204 provides the same update (e.g., “Show Climate Page”) to the page manager circuitry 202 in response to any of multiple different conditions (e.g., “Cabin Seat Position Changed” or “Operator Log-In Changed”) becoming satisfied. In some examples, a page referenced in the UI update of a trigger is only accessible when the condition of said trigger is satisfied. In other examples, the page referenced in the UI update of a trigger is accessible through other links or buttons on the UI. In such other examples, the automatic transition to the page that occurs when the corresponding condition is satisfied still reduces navigational complexity when compared to alternative techniques to access the page.

Like the accepted triggers 702, the recommended triggers 704 may include any combination of monitored vehicle usage data parameters, any type of logic that combines the parameters together to form a condition, any type of UI update, and any combination of vehicle usage data parameters shown in the UI update. But unlike the accepted triggers 702, the trigger control circuitry 204 does not monitor the vehicle usage data 214 to determine whether any of the conditions in the recommended triggers 704 have been satisfied. Thus, updates to the UI in the “then” column of the recommended triggers 704 are not implemented by the page manager circuitry 202, even when the corresponding condition happens to become satisfied.

An operator can instruct the control system 114 to begin implementing a recommended trigger 704A by navigating to the trigger page 700 and pressing an “accept” or “approve” button. In response to such a button press, the user interface circuitry 108 generates a signal that causes the page manager circuitry 202 to move the corresponding trigger from the recommended triggers 704 to the accepted triggers 702 and causes the trigger control circuitry 204 to begin checking whether the corresponding condition has been satisfied.

In some examples, an operator may choose to edit the recommended trigger 704B before accepting it. Similarly, an operator may choose to edit an accepted trigger 702B that is currently being implemented. In response to one of the “edit” buttons being pressed in the trigger page 700, the page manager circuitry 202 presents tools (via a pop-up window or separate page) for the operator to select a different condition and/or a different update to the UI. In some examples, the edit tools include one or more drop-down lists where the operator can select various parameters within the vehicle usage data 214 to populate the condition or the UI update.

In some examples, an operator may choose to remove a recommended trigger 704C from the trigger page 700 by pressing the corresponding “reject” button. Similarly, an operator may choose to remove an accepted trigger 702C by pressing the corresponding “delete” button. Deleting an accepted trigger 702C causes the trigger control circuitry 204 to stop determining whether the condition in the trigger 702C has been satisfied, thereby preventing the UI update in the trigger from being implemented further.

In some examples, an operator may choose to add an accepted trigger 702-n by pressing the “add trigger” button. Like pressing an “edit” button, pressing the “accept” button causes the page manager circuitry 202 to present tools (via a pop-up window or separate page) for the operator to select a different condition and/or a different update to the UI. In some examples, the edit tools include one or more drop-down lists where the operator can select various parameters within the vehicle usage data 214 to populate the condition or the UI update. Thus, the sources of accepted triggers generally come from one of three sources: 1) pre-determined triggers that are produced by developers of the UI and stored in the memory 112 during the manufacture of the vehicle, 2) triggers that are recommended by the model executor circuitry 208 while the vehicle 100 is in use, and 3) triggers that are manually added by an operator.

While an example manner of implementing the vehicle 100 and server circuitry 118 of FIG. 1 is illustrated in FIGS. 2 and 3, one or more of the elements, processes, and/or devices illustrated in FIG. FIGS. 2 and 3 may be combined, divided, re-arranged, omitted, eliminated, and/or implemented in any other way. Further, the page manager circuitry 202, the trigger control circuitry 204, the network interface circuitry 206, the model executor circuitry 208, the network interface circuitry 302, the model trainer circuitry 304, the data distribution circuitry 308, and/or, more generally, the example vehicle 100 and server circuitry 118 of FIGS. 2 and 3, may be implemented by hardware alone or by hardware in combination with software and/or firmware. Thus, for example, any of the page manager circuitry 202, the trigger control circuitry 204, the network interface circuitry 206, the model executor circuitry 208, the network interface circuitry 302, the model trainer circuitry 304, the data distribution circuitry 308, and/or, more generally, the example vehicle 100 and server circuitry 118 of FIGS. 2 and 3, could be implemented by programmable circuitry in combination with machine-readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example vehicle 100 and/or server circuitry 118 of FIGS. 2 and 3 may include one or more elements, processes, and/or devices in addition to, or instead of, those illustrated in FIGS. 2 and 3, and/or may include more than one of any or all of the illustrated elements, processes and devices.

Flowchart(s) representative of example machine-readable instructions, which may be executed by programmable circuitry to implement and/or instantiate the vehicle 100 and/or server circuitry 118 of FIGS. 2 and 3 and/or representative of example operations which may be performed by programmable circuitry to implement and/or instantiate the vehicle 100 and/or server circuitry 118 of FIGS. 2 and 3, are shown in FIGS. 8, 9, 10, and/or 11. The machine-readable instructions may be one or more executable programs or portion(s) of one or more executable programs for execution by programmable circuitry such as the programmable circuitry 1212 shown in the example programmable circuitry platform 1200 described below in connection with FIG. 12 and/or may be one or more function(s) or portion(s) of functions to be performed by the example programmable circuitry (e.g., an FPGA) described below in connection with FIGS. 13 and/or 14. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8, 9, 10, and/or 11, many other methods of implementing the example vehicle 100 and/or server circuitry 118 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8, 9, 10, and/or 11 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine-readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine-readable instructions, etc., and/or manufactured to execute computer-readable instructions, machine-readable instructions, etc.

FIG. 8 is a flowchart representative of example machine-readable instructions and/or example operations 800 that may be executed, instantiated, and/or performed by programmable circuitry to implement accepted triggers. The example machine-readable instructions and/or the example operations 800 of FIG. 3 begin when the trigger control circuitry 204 monitor accepted trigger conditions. (Block 802). To do so, the trigger control circuitry 204 repeatedly reads the memory 112 to determine the current value of specific parameters within the vehicle usage data 214. The monitored parameters of block 802 are those listed within the conditions of the accepted triggers 210. In the example of FIG. 8, the trigger control circuitry 204 implements block 802 continuously in parallel with blocks 804-810.

The trigger control circuitry 204 selects a condition within the accepted triggers 210. (Block 804). The trigger control circuitry 204 then determines whether the condition of the selected trigger has been met. (Block 806). The trigger control circuitry 204 determines the condition has been met by evaluating the logic stated within the condition. Accordingly, the trigger control circuitry 204 may evaluate block 806 by checking whether certain combinations of the parameters from block 802: are within a threshold range, combine to form a threshold value, were updated in a threshold amount of time, etc. In some examples, the trigger control circuitry 204 determines the condition of block 806 by monitoring a second amount of the vehicle usage data 214 that is collected after a first amount of the vehicle usage data 214 that is used to execute the local model 216.

A condition has been met/satisfied when the logic of the condition resolves to “true.” Similarly, a condition has not been met/satisfied when the logic of the condition resolves to “false.” In some examples, the trigger control circuitry 204 performs different logical operations to execute block 806 in addition to or in replacement of the foregoing operations.

If the condition of the selected has not been met (Block 806: No), control proceeds to block 810. Alternatively, if the condition of the selected has been met (Block 806: Yes), the trigger control circuitry 204 and the page manager circuitry 202 update the UI based on the selected trigger. (Block 808). To do so, the trigger control circuitry 204 accesses the UI update instructions of the condition stored in memory 112 and provides the instructions to the page manager circuitry 202. The page manager circuitry 202 then uses the instructions to update the visuals presented on the display of the user interface circuitry 108. The UI update of block 808 presents specific portions of the vehicle usage data 214 to an operator without requiring user input, thereby reducing navigational complexity, increasing efficiency of task performance, and improving user experience.

After block 808, or if the condition of the selected trigger has not been met at block 806, the trigger control circuitry 204 determines whether the vehicle is still powered on. (Block 810). If the vehicle is powered off (Block 810: No), the machine-readable instructions and/or operations 800 end. However, if the vehicle remains powered on (Block 810: Yes), control returns to block 804 where the trigger control circuitry 204 selects another condition within the accepted triggers. The trigger control circuitry 204 continues to check conditions in such examples because, in general, one or more portions of the vehicle usage data 214 may change values at any time when the vehicle 100 is powered on. Accordingly, the trigger selected at the next iteration of block 804 may be the same trigger as the previous iteration or a different trigger, as any condition may be satisfied at any time when the vehicle 100 is powered on. In some examples, the control system 114 implements multiple instances of blocks 804-810 in parallel to evaluate multiple conditions at the same time.

FIG. 9 is a flowchart representative of example machine-readable instructions and/or example operations 900 that may be executed, instantiated, and/or performed by example programmable circuitry to recommend a trigger. In the example of FIG. 9, the machine-readable instructions and/or operations 900 begin when the model executor circuitry 208 collects vehicle usage data 214. (Block 902). While the monitoring of block 802 of FIG. 8 is limited to specific parameters specified within the conditions of the accepted triggers 210, the collection of block 902 may include the recordation of any and all parameter values within the vehicle usage data 214. In some examples, the collection of block 902 also includes recording multiple versions of the same vehicle usage data 214 parameters at different points in time. Accordingly, the operations of block 902 may capture how signals from any of the actuators 104, sensors 106, user interface circuitry 108, and/or cabin input devices 110 change over time based on how a particular operator prefers to use the vehicle 100.

The model executor circuitry 208 creates a recommended trigger based on the monitoring operations of block 902. (Block 904). To do so, the model executor circuitry 208 executes the local model 216 using one or more portions of data recorded at block 902. The local model 216 may be a regression model, a decision tree, a neural network, etc. as described above. The output of the execution of the local model 216 includes both a condition and UI update instructions. The model executor circuitry 208 stores the foregoing results in the memory 112 as one of the recommended triggers 212.

The network interface circuitry 206 reports the recommended triggers of block 904 and/or the monitoring data of block 902 to the server circuitry 118. (Block 906). The server circuitry 118 uses the transmitted data for model training as described further in connection with FIG. 10.

The page manager circuitry 202 determines whether the recommended trigger has been accepted. (Block 908). In some examples, an operator accepts the recommended trigger by navigating to the trigger page 700 shown in FIG. 7 and pressing the corresponding “accept” button. In other examples, an operator accepts the recommended trigger through a different technique (e.g., a pop-up window that appears on the UI as soon as the recommended trigger is available or after the next power cycle of the vehicle 100, etc.). An operator may accept one or more of the recommended triggers 212 at any time. Accordingly, in some examples, the page manager circuitry 202 repeatedly executes block 908 to see if the operator has accepted any recommendations since the last check.

If the recommended trigger has been accepted (Block 908: Yes), the trigger control circuitry 204 implements the accepted trigger. (Block 910). Implementing the accepted trigger is described above in connection with FIG. 8. The machine-readable instructions and/or operations 900 end after block 910 or if the recommended trigger has not been accepted (Block 908: No).

In some examples, the control system 114 may implement one or more of the operations of FIG. 9 in parallel with one another. For example, the model executor circuitry 208 may generate recommended triggers based on existing monitor data at block 904 while recording additional monitor data to capture subsequent changes. Similarly, an operator may accept one of the existing recommended triggers 212 at block 908 during additional monitoring operations at block 902 and/or additional recommendation operations at block 904.

FIG. 10 is a flowchart representative of example machine-readable instructions and/or example operations 1000 that may be executed, instantiated, and/or performed by example programmable circuitry to train a trigger recommendation model. In the example of FIG. 10, the machine-readable instructions and/or operations 1000 begin when the network interface circuitry 302 receives vehicle usage data 214 from one or more vehicles. (Block 10002). The vehicles may be used in any industry (e.g., agriculture, aerospace, automotive, etc.), may belong to different makes or models, etc.

The network interface circuitry 302 receives recommended and accepted triggers from the one or more vehicles of block 1002. (Block 1004). The triggers show which conditions and UI update instructions are currently in use by vehicle operators, currently being suggested by vehicle operators, etc.

The network interface circuitry 302 receives pre-determined triggers. (Block 1006). The pre-determined triggers are values that are manually formed by a developer or manufacturer of the vehicle 100 or the server circuitry 118. In some examples, the pre-determined triggers are referred to as labelled training data and/or ground truth data because they can be used as an example of a valid / useful trigger during model training. In the example of FIG. 8, the network interface circuitry 302 implements one or more of blocks 1002, 1004, and 1006 continuously and in parallel with the loop of blocks 1008-1012.

The model trainer circuitry 304 trains a machine learning model based on the received data of blocks 1002-1006. (Block 1008). The machine learning model is trained to monitor the vehicle usage data of a vehicle 100 and to output trigger recommendations that are customized to the operator(s) of that vehicle 100. The model trainer circuitry 304 may use any type of machine learning architecture, any loss function, etc. to train the machine learning model as described above in connection to FIG. 3.

The data distribution circuitry 308 distributes trigger data. (Block 1010). The data includes but is not limited to a copy of the machine learning model trained at block 1008. Block 1010 is described further in connection with FIG. 11.

The model trainer circuitry 304 determines whether to retrain the model. (Block 1012). The model trainer circuitry 304 makes the determination of block 1012 based on feedback data that has been received after the trigger data distribution of block 1010. In general, feedback data refers to any data that is indicative of the performance of the machine learning model. Such data may quantify how many recommended triggers are being generated, describe the conditions and the UI update instructions within the recommended triggers, indicate which recommended triggers are being accepted, edited, or rejected, etc. Accordingly, the model trainer circuitry 304 may use any of the vehicle usage data of block 1002 or recommended and accepted triggers of block 1004 as feedback. In some examples, the model trainer circuitry 304 retrains the model if a quantified performance of the model, which is based on but is not limited to the foregoing factors, is below a threshold value.

If the model trainer circuitry 304 decides to retrain the model (Block 1012: Yes), control returns to block 1008 where the model trainer circuitry 304 retrains the model in view of the feedback data. If the model trainer circuitry 304 decides not to retrain the model (Block 1012: No), the machine-readable instructions and/or operations 1000 end.

FIG. 11 is a flowchart representative of example machine-readable instructions and/or example operations that may be executed, instantiated, and/or performed by example programmable circuitry to distribute trigger data as described in FIG. 10. In particular, the flowchart of FIG. 11 is an example implementation of block 1010 of FIG. 10.

Execution of block 1010 begins when the data distribution circuitry 308 provides a copy of the trained machine learning model to one or more vehicles. (Block 1102). In general, different types of vehicles generate different vehicle usage data. Accordingly, a given version of the machine learning model may recommend triggers based on vehicle usage data that is supported by some vehicles but not others. In some examples, the model trainer circuitry 304 generates different versions of a trigger recommendation model at block 1008 of FIG. 10 that corresponds to different vehicles. Accordingly, the data distribution circuitry 308 executes block 1102 by providing a version of the trained machine learning model to one or more vehicles that generate the same vehicle usage data that the model version is trained on.

The data distribution circuitry 308 determines whether the one or more vehicles of block 1102 have received pre-determined triggers previously. (Block 1104). If the vehicles have not received pre-determined triggers yet (Block 1104: No), the data distribution circuitry 308 provides the one or more vehicles with one or more corresponding, pre-determined triggers from block 1006 of FIG. 10. (Block 1106). Thus, the triggers of blocks 1006 and 1106 can form one or more of the accepted triggers 210 or recommended triggers 212 that are stored in memory 112 before the vehicle 100 is sold. In this example, the data distribution circuitry 308 implements block 1106 because the manually created triggers that are deemed sufficiently valuable for use in model training (see, e.g., block 1006 above) are also sufficiently valuable to be used as a set of default triggers for a fleet of vehicles. In other examples, one or more of the default triggers stored in the memory 112 during the manufacture of the vehicle 100 are different from the pre-determined triggers used for model training. A trigger corresponds to a vehicle if the condition of the trigger can be evaluated, and UI update instructions of the trigger can be implemented, using the set of vehicle usage data generated by the vehicle. Control returns to block 1012 of FIG. 10 after block 1106.

Alternatively, if the vehicles have already received pre-determined triggers (Block 1104: Yes), control returns directly to block 1012 without the intermediate execution of block 1012 described above. Trigger distribution is skipped in such examples because retraining a machine learning model at block 1008 creates a new version of the model but does not guarantee that additional pre-determined triggers will be manually created. More generally, a developer of the trigger recommendation models can retrain a model at any time and for any reason, and can develop additional pre-determined triggers at any time and for any reason, such that model retraining and manual trigger creation are independent of one another.

FIG. 12 is a block diagram of an example programmable circuitry platform 1200 structured to execute and/or instantiate the example machine-readable instructions and/or the example operations of FIGS. 8, 9, 10, and/or 11 to implement the vehicle 100 and/or server circuitry 118 of FIGS. 2 and 3. To implement the server circuitry 118, the programmable circuitry platform 1200 can be, for example, a server, a personal computer, a workstation, a self-learning machine (e.g., a neural network), a mobile device (e.g., a cell phone, a smart phone, a tablet such as an iPad^{TM}), an Internet appliance, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the page manager circuitry 202, the trigger control circuitry 204, the network interface circuitry 206, the model executor circuitry 208, the model trainer circuitry 304, and/or the data distribution circuitry 308.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216. In this example, the main memory 1214, 1216 implements the memory 112 and/or the training database 306.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 1220 implements the network interface circuitry 206 and/or the network interface circuitry 302.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system. In this example, the input device(s) 1222 implements the sensors 106, the user interface circuitry 108, and the cabin input devices 110.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU. In this example, the output device(s) implement the actuators 104.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 1232, which may be implemented by the machine-readable instructions of FIGS. 8, 9, 10, and/or 11, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 8, 9, 10, and/or 11 to effectively instantiate the circuitry of FIG. 2 as logic circuits to perform operations corresponding to those machine-readable instructions. In some such examples, the circuitry of FIGS. 2 and 3 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine-readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine-readable instructions and/or operations represented by the flowcharts of FIGS. 8, 9, 10, and/or 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer-based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those described herein. A GPU, DSP and/or other programmable device can also be an accelerator. Accelerators may be on-board the microprocessor 1300, in the same chip package as the microprocessor 1300 and/or in one or more separate packages from the microprocessor 1300.

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine-readable instructions. However, once configured, the FPGA circuitry 1400 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine-readable instructions represented by the flowchart(s) of FIGS. 8, 9, 10, and/or 11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 8, 9, 10, and/or 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8, 9, 10, and/or 11. As such, the FPGA circuitry 1400 may be configured and/or structured to effectively instantiate some or all of the operations/functions corresponding to the machine-readable instructions of the flowchart(s) of FIGS. 8, 9, 10, and/or 11 as dedicated logic circuits to perform the operations/functions corresponding to those software instructions in a dedicated manner analogous to an ASIC. Therefore, the FPGA circuitry 1400 may perform the operations/functions corresponding to the some or all of the machine-readable instructions of FIGS. 8, 9, 10, and/or 11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine-readable instructions of FIGS. 8, 9, 10, and/or 11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine-readable instructions represented by the flowchart(s) of FIGS. 8, 9, 10, and/or 11 to perform first operation(s)/function(s), the FPGA circuitry 1400 of FIG. 14 may be configured and/or structured to perform second operation(s)/function(s) corresponding to a second portion of the machine-readable instructions represented by the flowcharts of FIGS. 8, 9, 10, and/or 11, and/or an ASIC may be configured and/or structured to perform third operation(s)/function(s) corresponding to a third portion of the machine-readable instructions represented by the flowcharts of FIGS. 8, 9, 10, and/or 11.

It should be understood that some or all of the circuitry of FIGS. 2 and 3 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 1300 of FIG. 13 may execute machine-readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

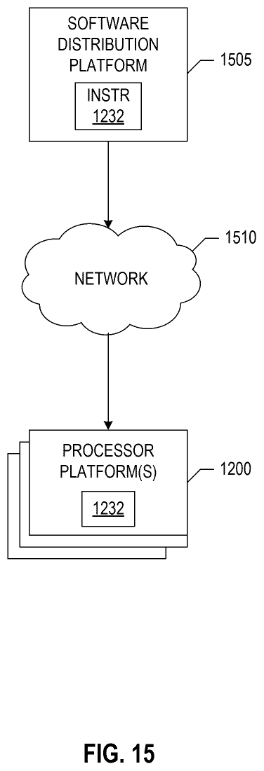

A block diagram illustrating an example software distribution platform 1505 to distribute software such as the example machine-readable instructions 1232 of FIG. 12 to other hardware devices (e.g., hardware devices owned and/or operated by third parties from the owner and/or operator of the software distribution platform) is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine-readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine-readable instructions 1232, which may correspond to the example machine-readable instructions of FIGS. 8, 9, 10, and/or 11, as described above. The one or more servers of the example software distribution platform 1505 are in communication with an example network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 1232 from the software distribution platform 1505. For example, the software, which may correspond to the example machine-readable instructions of FIGS. 8, 9, 10, and/or 11, may be downloaded to the example programmable circuitry platform 1200, which is to execute the machine-readable instructions 1232 to implement the vehicle 100 and/or server circuitry 118. In some examples, one or more servers of the software distribution platform 1505 periodically offer, transmit, and/or force updates to the software (e.g., the example machine-readable instructions 1232 of FIG. 12) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that reduces the complexity of navigating a user interface. Disclosed systems, apparatus, articles of manufacture, and methods improve the efficiency of using a computing device by monitoring vehicle usage data to determine whether trigger conditions are met, updating the UI to present relevant information when a condition is met, providing options for an operator to add, edit, delete or reject triggers, and implementing a machine learning model to recommend new triggers that are customized to the preferences and behaviors of a particular operator. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
a sensor;
an actuator;
user interface circuitry;
machine-readable instructions; and
programmable circuitry to at least one of instantiate or execute the machine-readable instructions to:
collect vehicle usage data that includes one or more of: a signal produced by the user interface circuitry, a signal produced by the sensor, or a signal produced by the actuator;
execute a machine learning model to a) generate a condition and b) identify information that corresponds to the condition, wherein the machine learning model uses a first amount of the vehicle usage data as an input;
determine the condition has been satisfied by monitoring a second amount of the vehicle usage data, wherein the second amount of the vehicle usage data is collected after the first amount; and
in response to the determination, update the user interface circuitry to present the information.

2. The vehicle of claim 1, wherein:
the user interface circuitry is presenting a first page before the programmable circuitry determines the condition has been satisfied; and
to update the user interface circuitry, the programmable circuitry instructs the user interface circuitry to switch from the first page to a second page that contains the information.

3. The vehicle of claim 1, wherein:
the user interface circuitry is presenting a page before the programmable circuitry determines the condition has been satisfied; and
to update the user interface circuitry, the programmable circuitry instructs the user interface circuitry to present a pop-up window overlaid on the page, the pop-up window to contain the information.

4. The vehicle of claim 1, wherein the programmable circuitry is to receive one or more of the signals produced by the sensor or the actuator over a controller area network (CAN) bus.

5. The vehicle of claim 1, wherein:
the vehicle is an agricultural vehicle; and
the sensor is a first sensor in a plurality of sensors that generate part of the vehicle usage data, the plurality of sensors including one or more of a global positioning sensor, an inertial sensor, a camera sensor or a temperature sensor.

6. The vehicle of claim 1, wherein:
the vehicle is an agricultural vehicle; and
the actuator is a first actuator in a plurality of actuators that generate part of the vehicle usage data, the plurality of actuators including one or more of an engine, a transmission, an axle, a crop header, an auger, or a device connected to the agricultural vehicle on a hitch.

7. The vehicle of claim 1, wherein:
the condition and the corresponding information form a first trigger in a plurality of triggers; and
the programmable circuitry is to:
monitor the second amount of vehicle usage data to determine whether one or more of the conditions in the plurality of triggers have been satisfied; and
in response to a determination that a condition in the plurality of triggers has been satisfied, update the user interface circuitry to present information from the corresponding trigger.

8. The vehicle of claim 7, wherein one or more of the plurality of triggers are pre-determined triggers that are stored in a memory of the vehicle before the user interface circuitry, the sensor, or the actuator generate part of the vehicle usage data.

9. The vehicle of claim 7, wherein the programmable circuitry is to instruct the user interface circuitry to present a page where a user can edit one or more of the plurality of triggers.

10. The vehicle of claim 7, wherein the programmable circuitry is to instruct the user interface circuitry to present a page where a user can add a trigger to the plurality of triggers.

11. The vehicle of claim 7, wherein the programmable circuitry is to instruct the user interface circuitry to present a page where a user can remove one or more of the plurality of triggers.

12. The vehicle of claim 7, wherein:
the plurality of triggers includes a group of accepted triggers and a group of recommended triggers;
the one or more conditions monitored by the programmable circuitry are part of the accepted triggers; and
the programmable circuitry is to move a trigger from the group of recommended triggers to the group of accepted triggers in response to a user input that approves of the trigger.

13. The vehicle of claim 12, wherein the programmable circuitry is to report one or more of the vehicle usage data, the recommended triggers, or the accepted triggers to an external device via a network.

14. A method for updating user interface circuitry, the method comprising:
collecting vehicle usage data that includes one or more of: a signal produced by the user interface circuitry, a signal produced by a sensor, or a signal produced by an actuator;
executing a machine learning model to a) generate a condition and b) identify information that corresponds to the condition, wherein the machine learning model uses a first amount of the vehicle usage data as an input;
determining the condition has been satisfied by monitoring a second amount of the vehicle usage data, wherein the second amount of the vehicle usage data is collected after the first amount; and
in response to the determination, updating the user interface circuitry to present the information.

15. The method of claim 14, further including:
presenting a first page on the user interface circuitry before the condition has been satisfied; and
updating the user interface by switching from the first page to a second page that contains the information.

16. The method of claim 14, further including:
presenting a page on the user interface circuitry before the condition has been satisfied; and
updating the user interface by presenting a pop-up window overlaid on the page, the pop-up window to contain the information.

17. The method of claim 14, further including receiving one or more of the signals produced by the sensor or the actuator over a controller area network (CAN) bus.

18. The method of claim 14, wherein:
the vehicle usage data corresponds to an agricultural vehicle; and
the sensor is a first sensor in a plurality of sensors that generate part of the vehicle usage data, the plurality of sensors including one or more of a global positioning sensor, an inertial sensor, a camera sensor or a temperature sensor.

19. A non-transitory machine-readable storage medium comprising instructions to cause programmable circuitry to at least:
collect vehicle usage data that includes one or more of: a signal produced by user interface circuitry, a signal produced by a sensor, or a signal produced by an actuator;
execute a machine learning model to a) generate a condition and b) identify information that corresponds to the condition, wherein the machine learning model uses a first amount of the vehicle usage data as an input;
determine the condition has been satisfied by monitoring a second amount of the vehicle usage data, wherein the second amount of the vehicle usage data is collected after the first amount; and
in response to the determination, update the user interface circuitry to present the information.

20. The non-transitory machine-readable storage medium of claim 19, wherein:
the user interface circuitry is presenting a first page before the programmable circuitry determines the condition has been satisfied; and
to update the user interface circuitry, the programmable circuitry instructs the user interface circuitry to switch from the first page to a second page that contains the information.
